(19) United States
(12) Patent Application Publication
(10) Pub. No.: US 2023/0389574 A1
(43) Pub. Date: Dec. 7, 2023

(54) Pet Food Compositions

(71) Applicant: Hill's Pet Nutrition, Inc., Topeka, KS (US)

(72) Inventors: Dennis JEWELL, Lawrence, KS (US); Laura MORGAN, Saint George, KS (US); Matthew JACKSON, Topeka, KS (US)

(73) Assignee: Hill's Pet Nutrition, Inc., Topeka, KS (US)

(21) Appl. No.: 18/249,490

(22) PCT Filed: Oct. 21, 2021
(86) PCT No.: PCT/US2021/055951

§ 371 Date: Apr. 18, 2023

Related U.S. Application Data
(60) Provisional application No. 63/094,605, filed on Oct. 21, 2020.

(51) Int. Cl. A23K 20/158; A23K 20/147; A23K 50/42

(52) U.S. Cl. CPC A23K 20/158; A23K 20/147; A23K 50/42

(57) ABSTRACT

Described herein are pet food compositions and methods for using them. Such compositions may comprise betaine and at least two omega-3 polyunsaturated fatty acids; wherein each of the at least two omega-3 polyunsaturated fatty acids comprise an unbranched aliphatic tail having at least 20 carbons. The methods may include feeding the pet an effective amount of the pet food composition.

### CROSS-REFERENCE TO RELATED APPLICATION

This application claims the benefit of priority from U.S. Provisional Application No. 63/094,605, filed Oct. 21, 2020, the contents of which are hereby incorporated herein by reference in their entirety.

### BACKGROUND

The present disclosure relates generally to food compositions, more specifically to pet food compositions and/or pet food products, such as compositions and/or products for feeding to cats or dogs.

The well-being of domestic animals is closely related to their feeding. Correct feeding should result in a fit and healthy pet. Such correct feeding may include utilizing ingredients which have beneficial effects for the animal.

It would be desirable to provide a pet food composition which increases circulatory amounts of such ingredients, such as polyunsaturated fatty acids and/or vitamin E.

### BRIEF SUMMARY

This summary is intended merely to introduce a simplified summary of some aspects of one or more implementations of the present disclosure. Further areas of applicability of the present disclosure will become apparent from the detailed description provided hereinafter. This summary is not an extensive overview, nor is it intended to identify key or critical elements of the present teachings, nor to delineate the scope of the disclosure. Rather, its purpose is merely to present one or more concepts in simplified form as a prelude to the detailed description below.

Applicants have discovered that providing a pet food diet comprising betaine and least two omega-3 polyunsaturated fatty acids, wherein each of the at least two omega-3 polyunsaturated fatty acids comprise an unbranched aliphatic tail having at least 20 carbons, provides for enhanced health benefit for the pet.

In at least one embodiment, the present invention is directed to a pet food composition comprising betaine and at least two omega-3 polyunsaturated fatty acids, wherein each of the at least two omega-3 polyunsaturated fatty acids comprise an unbranched aliphatic tail having at least 20 carbons. In certain embodiments, the at least two omega-3 polyunsaturated fatty acids comprise eicosapentaenoic acid (EPA) and docosahexaenoic acid (DHA). In certain embodiments, the at least two omega-3 polyunsaturated fatty acids are present in an amount of from about 0.09 to about 2.2 weight %, about 0.1 to about 0.8 weight %, or about 0.2 to about 0.5 weight %, based on the dry weight of the pet food composition. In certain embodiments, the at least two omega-3 polyunsaturated fatty acids are derived from fish oil.

In certain embodiments, the betaine is present in an amount of about 0.03 to about 1%, based on the dry weight of the pet food composition. In certain embodiments, the weight ratio of betaine to the at least two omega-3 polyunsaturated fatty acids is from about 1:1 to about 2.5:1. In certain embodiments, the weight ratio of betaine to the at least two omega-3 polyunsaturated fatty acids is from about 1.3:1 to about 2.0:1. In certain embodiments, the weight ratio of betaine to the at least two omega-3 polyunsaturated fatty acids is about 1.7:1. In certain embodiments, the betaine and the at least two omega-3 polyunsaturated fatty acids are present in an amount of from about 0.3% to about 1%, based on the dry weight of the pet food composition.

In certain embodiments, the composition further comprises alpha-linolenic acid. In certain embodiments, the alpha-linolenic acid is present in an amount of from about 0.3% to about 1%, based on the dry weight of the pet food composition.

In other embodiments, the invention is a method for increasing the amount of circulating vitamin E within a canine, comprising feeding the canine a pet food composition comprising betaine and at least two omega-3 polyunsaturated fatty acids in an amount effective to increase the circulating vitamin E within the canine, wherein each of the at least two omega-3 polyunsaturated fatty acids comprise an unbranched aliphatic tail having at least 20 carbons. In certain embodiments, the at least two omega-3 polyunsaturated fatty acids comprise eicosapentaenoic acid (EPA) and docosahexaenoic acid (DHA). In certain embodiments, the at least two omega-3 polyunsaturated fatty acids are present in an amount of from about 0.0.9% to about 1%, about 0.1% to about 0.8%, or about 0.2% to about 0.5%, based on the dry weight of the pet food composition. In certain embodiments, the betaine is present in an amount of 0.03 to 1%, %, based on the dry weight of the pet food composition. In certain embodiments, the weight ratio of betaine to the at least two omega-3 polyunsaturated fatty acids is from 1:1 to 2.5:1, from 1.3:1 to 2.0:1, or about 1.7:1. In certain embodiments, the betaine and the at least two omega-3 polyunsaturated fatty acids are present in an amount of from about 0.3 to about 1 weight %, based on the dry weight of the pet food composition. In certain embodiments, the at least two omega-3 polyunsaturated fatty acids are derived from fish oil. In certain embodiments, the composition further comprises alpha-linolenic acid. In certain embodiments, the alpha-linolenic acid is present in an amount of from about 0.3 to about 1 weight %, based on the dry weight of the pet food composition.

In other embodiments, the invention is a method for increasing the amount of circulating EPA and DHA within a feline, comprising feeding the feline a pet food composition comprising betaine and at least two omega-3 polyunsaturated fatty acids in an amount effective to increase the circulating EPA and DHA within the feline, wherein each of the at least two omega-3 polyunsaturated fatty acids comprise an unbranched aliphatic tail having at least 20 carbons. In certain embodiments, the at least two omega-3 polyunsaturated fatty acids comprise eicosapentaenoic acid (EPA) and docosahexaenoic acid (DHA). In certain embodiments, the at least two omega-3 polyunsaturated fatty acids are present in an amount of from about 0.2 to about 1 weight %, about 0.2 to about 0.8 weight %, or about 0.2 to about 0.5 weight %, based on the dry weight of the pet food composition. In certain embodiments, the ratio of betaine to the at least two omega-3 polyunsaturated fatty acids is from 1:1 to 2.5:1, from 1.3:1 to 2.0:1, or about 1.7:1. In certain embodiments, the betaine is present in an amount of 0.03 to 1 weight %, based on the dry weight of the pet food composition. In certain embodiments, the at least two omega-3 polyunsaturated fatty acids are derived from fish oil. In certain embodiments, the composition further comprises alpha-linolenic acid. In certain embodiments, the alpha-linolenic acid is present in an amount of from about 0.3 to about 1 weight %, based on the dry weight of the pet food composition.

Further areas of applicability of the present invention will become apparent from the detailed description provided hereinafter. It should be understood that the detailed description and specific examples, while indicating the typical embodiments of the invention, are intended for purposes of illustration only and are not intended to limit the scope of the invention.

Further areas of applicability of the present disclosure will become apparent from the detailed description provided hereinafter. It should be understood that the detailed description and specific examples, while indicating the preferred embodiment of the disclosure, are intended for purposes of illustration only and are not intended to limit the scope of the disclosure.

### DETAILED DESCRIPTION

For illustrative purposes, the principles of the present invention are described by referencing various exemplary embodiments thereof. Although certain embodiments of the invention are specifically described herein, one of ordinary skill in the art will readily recognize that the same principles are equally applicable to, and can be employed in other applications and methods. It is to be understood that the invention is not limited in its application to the details of any particular embodiment shown. The terminology used herein is for the purpose of description and not to limit the invention, its application, or uses.

As used herein and in the appended claims, the singular forms “a”, “an”, and “the” include plural references unless the context dictates otherwise. The singular form of any class of the ingredients refers not only to one chemical species within that class, but also to a mixture of those chemical species. The terms “a” (or “an”), “one or more” and “at least one” may be used interchangeably herein. The terms “comprising”, “including”, “containing”, and “having” may be used interchangeably. The term “include” should be interpreted as “include, but are not limited to”. The term “including” should be interpreted as “including, but are not limited to”.

As used throughout, ranges are used as shorthand for describing each and every value that is within the range. Any value within the range can be selected as the terminus of the range.

Unless otherwise specified, all percentages and amounts expressed herein and elsewhere in the specification should be understood to refer to percentages by weight of the total composition. Unless otherwise specified, reference to a molecule, or to molecules, being present at a “weight %” or “wt. %” refers to the amount of that molecule, or molecules, present in the composition based on the total weight of the composition.

According to the present application, use of the term “about” in conjunction with a numeral value refers to a value that may be +/−5% of that numeral. As used herein, the term “substantially free” is intended to mean an amount less than about 5.0 wt. %, less than 3.0 wt. %, 1.0 wt. %; preferably less than about 0.5 wt. %, and more preferably less than about 0.25 wt. % of the composition.

Unless defined otherwise, all technical and scientific terms used herein have the same meanings as commonly understood by one of ordinary skill in the art to which this invention belongs. All patents, patent applications, publications, and other references cited or referred to herein are incorporated by reference in their entireties for all purposes. In the event of a conflict in a definition in the present disclosure and that of a cited reference, the present disclosure controls.

The present disclosure is directed toward pet food compositions and methods of using such pet food compositions for the treatment of domestic pets. In certain embodiments, the pet is a dog. In other embodiments, the pet is a cat. Although the methods disclosed herein may be used for domestic pets, the methods may be used for livestock, such as cattle, sheep, pigs, and the like, or horses, donkeys, or other farm animals.

The present inventors have surprisingly and unexpectedly discovered that providing a pet food diet comprising betaine and least two omega-3 polyunsaturated fatty acids, wherein each of the at least two omega-3 polyunsaturated fatty acids comprise an unbranched aliphatic tail having at least 20 carbons, provides for enhanced health benefit. Such enhanced health benefit is exemplified by numerous aspects. In a first aspect, the enhanced health benefit is a synergistic effect for an increase in the pet's circulatory concentration of the at least two omega-3 polyunsaturated fatty acid supplements, e.g., EPA and DHA. In another aspect, the enhanced health benefit is an increase in the pet's circulatory concentration of vitamin E, or alpha tocopherol. In some embodiments, the at least two omega-3 polyunsaturated fatty acids are in the form of omega-3 polyunsaturated fatty acids supplements.

In one aspect, the present disclosure provides pet food compositions comprising betaine and at least two omega-3 polyunsaturated fatty acids. The at least two omega-3 polyunsaturated fatty acids typically have at least one aliphatic tail of 14 or more carbons. In some instances, the aliphatic tail of the at least two omega-3 polyunsaturated fatty acids may have at least one tail of 16 or more carbons, 17 or more carbons, 18 or more carbons, or 20 or more carbons. For example, the at least two omega-3 polyunsaturated fatty acid may have at least one tail of 16 to 24 carbons, 17 to 24 carbons, 18 to 24 carbons, 19 to 24 carbons, 20 to 24 carbons; 16 to 23 carbons, 17 to 23 carbons, 18 to 23 carbons, 19 to 23 carbons, 20 to 23 carbons; 16 to 22 carbons, 17 to 22 carbons, 18 to 22 carbons, 19 to 22 carbons, or 20 to 22 carbons. Preferably, the pet food composition comprises at least two omega-3 polyunsaturated fatty acids, wherein each omega-3 polyunsaturated fatty acids has at least one aliphatic tail of 18 to 22 carbons. In at least one embodiment, each of the at least two omega-3 polyunsaturated fatty acids comprise an unbranched aliphatic tail having at least 20 carbons.

The at least two omega-3 polyunsaturated fatty acid may comprise linolenic acid, stearidonic acid, eicosatetraenoic acid, eicosapentaenoic acid, docosapentaenoic acid, docosahexaenoic acid, or a combination of two or more thereof. In some cases, the at least two omega-3 polyunsaturated fatty acids may be selected from eicosapentaenoic acid, docosahexaenoic acid, linolenic acid, and a combination of two or more thereof. In certain embodiments, the at least two omega-3 polyunsaturated fatty acids comprise eicosapentaenoic acid (EPA) and docosahexaenoic acid (DHA).

Various omega-3 polyunsaturated fatty acid are useful within the invention. In certain embodiments, such fatty acids are long chain fatty acids having at least 20 carbons. In certain embodiments, the omega-3 polyunsaturated fatty acids are selected from eicosapentaenoic acid (EPA), docosahexaenoic acid (DHA), and mixtures thereof. Marine-based fish and fish oil are well-known sources of n−3 polyunsaturated fatty acids (PUFAs), namely, eicosapentaenoic acid (EPA) and docosahexaenoic acid (DHA). In certain embodiments, the fatty acids are derived from fish oil. Although the omega-3 polyunsaturated fatty acid may be obtained from an animal source, the omega-3 polyunsaturated fatty acid may be obtained from a plant source in some embodiments. Examples of plant sources for deriving or obtaining the fatty acids include, e.g., flaxseed, algae, avocado, hemp seeds, pumpkin seeds, sunflower seeds, walnuts, soya, or combinations of two or more thereof.

The at least two omega-3 polyunsaturated fatty acids may be present in an amount of from about 0.09 to about 2.2 weight %, about 0.09 to about 1.5 weight %, about 0.09 to about 1 weight %, about 0.1 to about 0.8 weight %, or about 0.2 to about 0.5 weight %, based on the dry weight of the pet food composition. For example, the at least two omega-3 polyunsaturated fatty acids may be present in an amount of about 0.09 wt. %, about 0.15 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1 wt. %, about 1.1 wt. %, about 1.2 wt. %, about 1.3 wt. %, about 1.4 wt. %, about 1.5 wt. %, or any range or subrange therebetween, based on the weight of the pet food composition. In another example, the at least two omega-3 polyunsaturated fatty acids may be present in an amount of from about 0.2 to about 2.2 weight %, about 0.2 to about 1 weight %, about 0.2 to about 0.8 weight %, or about 0.2 to about 0.5 weight %, based on the dry weight of the pet food composition. In another example, the at least two omega-3 polyunsaturated fatty acids may be present in an amount of from about 0.2 to about 2.2 weight %, about 0.2 wt. % to about 1.5 wt. %, about 0.2 wt. % to about 1.3 wt. %, about 0.2 wt. % to about 1 wt. %, about 0.2 wt. % to about 0.9 wt. %, about 0.2 wt. % to about 0.8 wt. %, about 0.2 wt. % to about 0.7 wt. %, or about 0.2 wt. % to about 0.6 wt. %, based on the dry weight of the pet food composition. In further examples, the pet food composition may comprise at least two omega-3 polyunsaturated fatty acids in an amount from about 0.4 to about 2.2 weight %, about 0.4% to about 1.5 weight %, about 0.4 to about 1.3 weight %, about 0.4 to about 1 weight %, about 0.4 to about 0.9 weight %, about 0.4 to about 0.8 weight %, about 0.4 to about 0.7 weight %; about 0.8 to about 2.2 weight %, about 0.8% to about 1.5 weight %, about 0.8 to about 1.3 weight %, about 0.8 to about 1 weight %; about 1.2 to about 2.2 weight %, about 1.2% to about 1.5 weight %, about 1.2 to about 1.3 weight %; about 1.6 to about 2.2 weight %, about 1.8 to about 2.2 weight %, or about 2 to about 2.2 weight %, based on the dry weight of the pet food composition.

Without being limited to any specific theory, the inventors discovered that certain pet food compositions comprising about 2.2 weight % or less of a combination of EPA and DHA may yield more of EPA and DHA in the blood of a pet than pet food compositions comprising more than about 2.2 weight % of the combination of EPA and DHA.

In some cases, the pet food composition has a weight ratio of eicosapentaenoic acid and docosahexaenoic acid (EPA:DHA) of from about 1:5 to about 5:1, about 1:4 to about 5:1, about 1:3 to about 5:1, about 1:2 to about 5:1, about 1:1 to about 5:1; about 2.5:5 to about 5:1, about 2.5:4 to about 5:1, about 2.5:3 to about 5:1; about 1:5 to about 2.5:1, about 1:4 to about 2.5:1, about 1:3 to about 2.5:1, about 1:2 to about 2.5:1, about 1:1 to about 2.5:1; about 1:5 to about 4:1, about 1:4 to about 3:1, about 1:3 to about 2:1, about 1:4 to about 1:1.

In at least one implementation, the pet food composition comprises betaine. Betaine is a modified amino acid consisting of glycine with three methyl groups that serves as a methyl donor in several metabolic pathways.

The amount or concentration of betaine present in the pet food composition may vary. In certain embodiments, the amount of betaine present in the pet food composition may be from about 0.03% to 1%, based on the total weight of the pet food composition. For example, the amount of betaine present in the pet food composition may be about 0.03 wt. %, about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1 wt. %, or any ranges or subranges therebetween, based on the total weight of the pet food composition. In some embodiments, the betaine is present in the pet food composition in an amount of from about 0.03 to about 2 wt. %, about 0.03 to about 1.7 wt. %, about 0.03 to about 1.5 wt. %, about 0.03 to about 1.3 wt. %, about 0.03 to about 0.9 wt. %, about 0.03 to about 0.7 wt. %, about 0.03 to about 0.6 wt. %, about 0.03 to about 0.5 wt. %, about 0.03 to about 0.4 wt. %, about 0.03 to about 0.3 wt. %, about 0.03 to about 0.2 wt. %, about 0.03 to about 0.1 wt. %; about 0.06 to about 2 wt. %, about 0.06 to about 1.7 wt. %, about 0.06 to about 1.5 wt. %, about 0.06 to about 1.3 wt. %, about 0.06 to about 0.9 wt. %, about 0.06 to about 0.7 wt. %, about 0.06 to about 0.6 wt. %, about 0.06 to about 0.5 wt. %, about 0.06 to about 0.4 wt. %, about 0.06 to about 0.3 wt. %, about 0.06 to about 0.2 wt. %, about 0.06 to about 0.1 wt. %; about 0.1 to about 2 wt. %, about 0.1 to about 1.7 wt. %, about 0.1 to about 1.5 wt. %, about 0.1 to about 1.3 wt. %, about 0.1 to about 0.9 wt. %, about 0.1 to about 0.7 wt. %, about 0.1 to about 0.6 wt. %, about 0.1 to about 0.5 wt. %, about 0.1 to about 0.4 wt. %, about 0.1 to about 0.3 wt. %; about 0.3 to about 2 wt. %, about 0.3 to about 1.7 wt. %, about 0.3 to about 1.5 wt. %, about 0.3 to about 1.3 wt. %, about 0.3 to about 0.9 wt. %, about 0.3 to about 0.7 wt. %, about 0.3 to about 0.6 wt. %, about 0.3 to about 0.5 wt. %; about 0.5 to about 2 wt. %, about 0.5 to about 1.7 wt. %, about 0.5 to about 1.5 wt. %, about 0.5 to about 1.3 wt. %, about 0.5 to about 0.9 wt. %, about 0.5 to about 0.7 wt. %; about 0.7 to about 2 wt. %, about 0.7 to about 1.7 wt. %, about 0.7 to about 1.5 wt. %, about 0.7 to about 1.3 wt. %, or about 0.7 to about 0.9 wt. %, including ranges and subranges therebetween, based on the total weight of the pet food composition.

In another embodiment, the amount of betaine present in the pet food composition may be from about 0.1 wt. % to about 0.9 wt. %, about 0.2 wt. % to about 0.8 wt. %, about 0.2 wt. % to about 0.7 wt. %, about 0.2 wt. % to about 0.6 wt. %, or about 0.2 wt. % to about 0.5 wt. %, based on the total weight of the pet food composition. In an example of an implementation, the amount of betaine present in the pet food composition may be from about 0.2 wt. % to about 0.7 wt. %, more typically about 0.55 wt. %, based on the total weight of the pet food composition.

The weight ratio of betaine to the at least two omega-3 polyunsaturated fatty acids may vary. For example, the food composition may have a weight ratio of the betaine to the at least two omega-3 polyunsaturated fatty acids of from about 1:2 to about 5:1, about 1:2 to about 4:1, about 1:2 to about 3:1, about 1:2 to about 2:1, about 1:2 to about 1:1; about 1:1 to about 5:1, about 1:1 to about 4:1, about 1:1 to about 3:1, about 1:1 to about 2:1; about 1.2:1 to about 5:1, about 1.2:1 to about 4:1, about 1.2:1 to about 3:1, about 1.2:1 to about 2:1, about 1.2:1 to about 1:1; about 1.4:1 to about 5:1, about 1.4:1 to about 4:1, about 1.4:1 to about 3:1, about 1.4:1 to about 2:1, about 1.4:1 to about 1:1; about 1.6:1 to about 5:1, about 1.6:1 to about 4:1, about 1.6:1 to about 3:1, about 1.6:1 to about 2:1, or about 1.6:1 to about 1:1, including ranges and subranges therebetween.

In certain embodiments, the ratio of betaine to the at least two omega-3 polyunsaturated fatty acids is from about 1:1 to about 2.5:1. For example, the weight ratio of betaine to the at least two omega-3 polyunsaturated fatty acids may be about 1.1:1, about 1.2:1, about 1.3:1, about 1.4:1, about 1.5:1, about 1.6:1, about 1.7:1, about 1.8:1, about 1.9:1, about 2:1, about 2.1:1, about 2.2:1, about 2.3:1, about 2.4:1, or about 2.5:1, including ranges and subranges therebetween. In certain embodiments, the weight ratio of betaine to the at least two omega-3 polyunsaturated fatty acids is from about 1.3:1 to about 2.0:1. In certain embodiments, the weight ratio of betaine to the at least two omega-3 polyunsaturated fatty acids is from about 1.5:1 to about 2:1. In further embodiments, the weight ratio of betaine to the at least two omega-3 polyunsaturated fatty acids is about 1.7:1.

Additionally and/or alternatively, the pet food compositions may have a weight ratio of the betaine to the total amount of eicosapentaenoic acid (EPA) and docosahexaenoic acid (DHA) of from about 1:2 to about 5:1, about 1:2 to about 4:1, about 1:2 to about 3:1, about 1:2 to about 2:1, about 1:2 to about 1:1; about 1:1 to about 5:1, about 1:1 to about 4:1, about 1:1 to about 3:1, about 1:1 to about 2:1; about 1.2:1 to about 5:1, about 1.2:1 to about 4:1, about 1.2:1 to about 3:1, about 1.2:1 to about 2:1, about 1.2:1 to about 1:1; about 1.4:1 to about 5:1, about 1.4:1 to about 4:1, about 1.4:1 to about 3:1, about 1.4:1 to about 2:1, about 1.4:1 to about 1:1; about 1.6:1 to about 5:1, about 1.6:1 to about 4:1, about 1.6:1 to about 3:1, about 1.6:1 to about 2:1, or about 1.6:1 to about 1:1, including ranges and subranges therebetween.

The amount or concentration of betaine and the at least two omega-3 polyunsaturated fatty acids may vary widely. In at least one example, the betaine and the at least two omega-3 polyunsaturated fatty acids may be present in an amount greater than or equal to 0.2 wt. % and less than or equal to 2 wt. %, based on the dry weight of the pet food composition. For example, the betaine and the at least two omega-3 polyunsaturated fatty acids may be present in an amount of from about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1 wt. %, about 1.2 wt. %, about 1.5 wt. %, about 1.7 wt. %, about 2 wt. %, about 2.2 wt. %, about 2.5 wt. %, or any range or subranges therebetween, based on the dry weight of the pet food composition. In another example, the betaine and the at least two omega-3 polyunsaturated fatty acids may be present in an amount of from about 0.2 wt. % to about 2 wt. %, about 0.2 wt. % to about 1.8 wt. %, about 0.2 wt. % to about 1.6 wt. %, about 0.3 wt. % to about 2.2 wt. %, about 0.3 wt. % to about 2 wt. %, about 0.3 wt. % to about 1.7 wt. %, about 0.3 wt. % to about 1.5 wt. %, about 0.3 wt. % to about 1.2 wt. %, about 0.5 wt. % to about 2.2 wt. %, about 0.5 wt. % to about 2 wt. %, about 0.5 wt. % to about 1.7 wt. %, about 0.5 wt. % to about 1.5 wt. %, about 0.5 wt. % to about 1.3 wt. %, about 0.5 wt. % to about 1 wt. %, or about 0.5 wt. % to about 0.8 wt. %, including any range or subranges therebetween, based on the weight of the pet food composition. In a preferred embodiment, the one or more gelling agents may be present in an amount of from about 0.3 wt. % to about 1.2 wt. %, about 0.3 wt. % to about 1 wt. %, or about 0.3 wt. % to about 0.8 wt. %, including any range or subranges therebetween, based on the dry weight of the pet food composition.

The compositions of the present invention may optionally comprise other fatty acids. In certain embodiments, the pet food composition may comprise alpha-linolenic acid (ALA). The alpha-linolenic acid may be present in an amount of from about 0.3 to about 1 weight %, based on the dry weight of the pet food composition. For example, the amount of alpha-linolenic acid present in the pet food composition may be about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, or about 1 wt. %, including any range or subranges therebetween, based on the weight of the pet food composition. In another embodiment, the amount of alpha-linolenic acid present in the pet food composition may be from about 0.1 wt. % to about 0.9 wt. %, about 0.1 wt. % to about 0.8 wt. %, about 0.1 wt. % to about 0.7 wt. %, about 0.1 wt. % to about 0.6 wt. %, or about 0.1 wt. % to about 0.5 wt. %, including any range or subranges therebetween, based on the weight of the pet food composition. In a typical implementation, the amount of alpha-linolenic acid present in the pet food composition may be from about 0.2 wt. % to about 0.6 wt. %, more typically about 0.55 wt. %, based on the weight of the pet food composition.

The compositions of the present invention may optionally comprise additional ingredients suitable for use in pet food compositions. Examples of such ingredients include, but are not limited to, carbohydrates, dietary fibers, amino acids, minerals, trace elements, vitamins, additives.

Carbohydrates can be supplied by any of a variety of sources known by those skilled in the art, including oat fiber, cellulose, peanut hulls, beet pulp, parboiled rice, corn starch, corn gluten meal, and any combination of those sources. Grains supplying carbohydrates can include, but are not limited to, wheat, corn, barley, and rice. Carbohydrates content of foods can be determined by any number of methods known by those of skill in the art. Generally, carbohydrate percentage can be calculated as nitrogen free extract (“NFE”), which can be calculated as follows: NFE=100%-moisture %-protein %-fat %-ash %-crude fiber %.

Dietary fiber refers to components of a plant which are resistant to digestion by an animal's digestive enzymes. Dietary fiber includes soluble and insoluble fibers. Soluble fibers are resistant to digestion and absorption in the small intestine and undergo complete or partial fermentation in the large intestine, e.g., beet pulp, guar gum, chicory root, psyllium, pectin, blueberry, cranberry, squash, apples, oats, beans, citrus, barley, or peas. Insoluble fibers can be supplied by any of a variety of sources, including, for example, cellulose, whole wheat products, wheat oat, corn bran, flax seed, grapes, celery, green beans, cauliflower, potato skins, fruit skins, vegetable skins, peanut hulls, and soy fiber. Crude fiber includes indigestible components contained in cell walls and cell contents of plants such as grains, for example, hulls of grains such as rice, corn, and beans. Typical fiber amounts in compositions of the present disclosure can be from about 0 to 10%, or about 1% to about 5%, based on the total weight of the pet food composition. For instance, the amount of fiber (e.g., crude fiber or dietary fiber) in the pet food composition may be from about 0.1 to about 10% by weight, about 0.1 to about 9% by weight, about 0.1 to about 8% by weight, about 0.1 to about 7% by weight, about 0.1 to about 6% by weight, about 0.1 to about 5% by weight, about 0.1 to about 4% by weight, about 0.1 to about 3% by weight, about 0.1 to about 2% by weight, about 0.1 to about 1% by weight; about 0.5 to about 10% by weight, about 0.5 to about 9% by weight, about 0.5 to about 8% by weight, about 0.5 to about 7% by weight, about 0.5 to about 6% by weight, about 0.5 to about 5% by weight, about 0.5 to about 4% by weight, about 0.5 to about 3% by weight, about 0.5 to about 2% by weight, about 0.5 to about 1% by weight; about 1 to about 10% by weight, about 1 to about 9% by weight, about 1 to about 8% by weight, about 1 to about 7% by weight, about 1 to about 6% by weight, about 1 to about 5% by weight, about 1 to about 4% by weight, about 1 to about 3% by weight, about 1 to about 2% by weight; about 1.5 to about 10% by weight, about 1.5 to about 9% by weight, about 1.5 to about 8% by weight, about 1.5 to about 7% by weight, about 1.5 to about 6% by weight, about 1.5 to about 5% by weight, about 1.5 to about 4% by weight, or about 1.5 to about 3% by weight, including ranges and subranges therebetween, based on the total weight of the pet food composition.

Amino acids, including essential amino acids, can be added to the compositions of the present disclosure as free amino acids, or supplied by any number of sources, e.g., crude protein, to the compositions of the present disclosure. Essential amino acids are amino acids that cannot be synthesized de novo, or in sufficient quantities by an organism and thus must be supplied in the diet. Essential amino acids vary from species to species, depending upon the organism's metabolism. For example, it is generally understood that the essential amino acids for dogs and cats (and humans) are phenylalanine, leucine, methionine, lysine, isoleucine, valine, threonine, tryptophan, histidine and arginine. In addition, taurine, while technically not an amino acid but a derivative of cysteine, is an essential nutrient for cats.

The pet food composition may comprise protein and/or a digestible crude protein. “Digestible crude protein” is the portion of protein that is available or can be converted into free nitrogen (amino acids) after digesting with gastric enzymes. In vitro measurement of digestible crude protein may be accomplished by using gastric enzymes such as pepsin and digesting a sample and measuring the free amino acid after digestion. In vivo measurement of digestible crude protein may be accomplished by measuring the protein levels in a feed/food sample and feeding the sample to an animal and measuring the amount of nitrogen collected in the animal's feces.

The protein and/or digestible crude protein of the composition may be present at various amounts or concentrations. In one embodiment, protein may be present in an amount of from about 10% to about 40%, based on the total weight of the pet food composition. For example, protein may be present in an amount of about 10 weight %, about 15 weight %, about 20 weight %, about 25 weight %, about 30 weight %, about 35 weight %, or about 40 weight %. In another example, protein may be present in an amount of from about 10% to about 25%, from about 15% to about 25%, or about 15% to about 20%, based on the total weight of the pet food composition. In certain embodiments, protein is present in an amount of about 12% to about 35%, about 13% to about 25%, or about 15% to about 25%, based on the total weight of the pet food composition.

A portion of the protein in the composition may be digestible protein. For example, the composition may include an amount of protein, where about 40 weight % or more, about 50 weight % or more, about 60 weight % or more, about 70 weight % or more, about 80 weight % or more, or about 90 weight % or more of the protein is digestible protein. In some embodiments, e.g., when the composition desirable promotes weight loss, the portion of protein that is digestible protein is about 60 weight % or less, about 50 weight % or less, about 40 weight % or less, about 30 weight % or less, about 20 weight % or less, or about 10 weight % or less, based on the total amount of protein in the composition. In further embodiment, the amount of protein that is digestible protein is about 10 to about 90 weight %, about 10 to about 70 weight %, about 10 to about 50 weight %, about 10 to about 30 weight %; about 30 to about 90 weight %, about 30 to about 70 weight %, about 30 to about 50 weight %; about 50 to about 90 weight %, about 50 to about 70 weight %; or about 70 to about 90 weight %, including ranges and subranges therein, based on the total amount of protein in the composition.

The compositions of the present invention may optionally comprise fat. The term “fat” generally refers to a lipid or mixture of lipids that may generally be a solid or a liquid at ordinary room temperatures (e.g., 25° C.) and pressures (e.g., 1 atm). In some instances, the fat may be a viscous liquid or an amorphous solid at standard room temperature and pressure.

Fat can be supplied by any of a variety of sources known by those skilled in the art, including meat, meat by-products, canola oil, fish oil, and plants. Plant fat sources include wheat, flaxseed, rye, barley, rice, sorghum, corn, oats, millet, wheat germ, corn germ, soybeans, peanuts, and cottonseed, as well as oils derived from these and other plant fat sources. The compositions of the present disclosure may contain about 9 or more by weight % (or from about 9 to about 25 weight %, or from about 10 to about 20 weight %, or from about 10 to about 15 weight %) of total fat, based on the total weight of the pet food composition. In some cases, the fat in the compositions is crude fat. Crude fat may be included into the compositions in amounts of from about 10 to about 20 weight %, about 10 to about 18 weight %, about 10 to about 16 weight %; about 12 to about 20 weight %, about 12 to about 18 weight %, or about 12 to about 16 weight %, based on the total weight of the composition. In some cases, it may be preferable that about 50 weight % or more, about 60 weight % or more, about 70 weight % or more, about 80 weight % or more, or about 90 weight % or more of the total fat is obtained from an animal source. Alternatively, about 50 weight % or more, about 60 weight % or more, about 70 weight % or more, about 80 weight % or more, or about 90 weight % or more of the total fat may be obtained from a plant source.

The pet food composition, in some cases, may include ash. The amount of ash preset in the food composition may be from about 1 to about 15% by weight, about 1 to about 13% by weight, about 1 to about 11% by weight, about 1 to about 10% by weight, about 1 to about 9% by weight, about 1 to about 8% by weight, about 1 to about 7% by weight, about 1 to about 6% by weight, about 1 to about 5% by weight, about 1 to about 4% by weight, about 1 to about 3% by weight; about 3 to about 15% by weight, about 3 to about 13% by weight, about 3 to about 11% by weight, about 3 to about 10% by weight, about 3 to about 9% by weight, about 3 to about 8% by weight, about 3 to about 7% by weight, about 3 to about 6% by weight, about 3 to about 5% by weight; about 4 to about 15% by weight, about 4 to about 13% by weight, about 4 to about 11% by weight, about 4 to about 10% by weight, about 4 to about 9% by weight, about 4 to about 8% by weight, about 4 to about 7% by weight; about 5 to about 15% by weight, about 5 to about 13% by weight, about 5 to about 11% by weight, about 5 to about 10% by weight, about 5 to about 9% by weight, about 5 to about 8% by weight, about 5 to about 7% by weight, including ranges and subranges therebetween, based on the weight of the pet food composition.

The compositions of the present disclosure can also contain one or more minerals and/or trace elements, e.g., calcium, phosphorus, sodium, potassium, magnesium, manganese, copper, zinc, chromium, molybdenum, selenium, or iron salts having counterions such as, for example chloride, iodide, fluoride, sulfide or oxide, in amounts required to avoid deficiency and maintain health. These amounts are known by those of skill in the art, for example, as provided in the Official Publication of the Associate of American Feed Control Officials, Inc. (“AAFCO”), Nutrient Requirements of Dogs and Cats, 2006. Typical mineral amounts are about 0.1% to about 4% or about 1% to about 2%.

The compositions of the present invention can also include vitamins in amounts required to avoid deficiency and maintain health. These amounts, and methods of measurement are known by those skilled in the art. For example, the Official Publication of the Associate of American Feed Control Officials, Inc. (“AAFCO”), Nutrient Requirements of Dogs and Cats, 2006 provides recommended amounts of such ingredients for dogs and cats. As contemplated herein, vitamins can include, but are not limited to, vitamin A, vitamin B.sub.1, vitamin B.sub.2, vitamin B.sub.6, vitamin B.sub.12, vitamin C, vitamin D, vitamin E, vitamin H (biotin), vitamin K, folic acid, choline, inositol, niacin, and pantothenic acid. Typical vitamin amounts in the composition of the invention are about from 0 to about 3% or about 1% to about 2%.

The compositions of the present disclosure can additionally comprise other additives such as palatability enhancers and stabilizers in amounts and combinations familiar to one of skill in the art. Stabilizing substances include, for example, substances that tend to increase the shelf life of the composition. Other examples of other such additives potentially suitable for inclusion in the compositions of the invention include, for example, preservatives, colorants, antioxidants, flavorants, synergists and sequestrants, packaging gases, stabilizers, emulsifiers, thickeners, gelling agents, and humectants. Examples of emulsifiers and/or thickening agents include, for example, gelatin, cellulose ethers, starch, starch esters, starch ethers, and modified starches. The concentration of such additives in the composition typically can be up to about 5% by weight. In some embodiments, the concentration of such additives (particularly where such additives are primarily nutritional balancing agents, such as vitamins and minerals) is from about 0% to about 2.0% by weight. In some embodiments, the concentration of such additives (again, particularly where such additives are primarily nutritional balancing agents) is from about 0% to about 1.0% by weight.

Foods of any consistency or moisture content are contemplated, e.g., the compositions of the present invention can be, for example, a dry, moist or semi-moist animal food composition. In some embodiments, the moisture content is from about 3% to about 90% of the total weight of the composition. “Semi-moist” refers to a food composition containing from about 25 to about 35% moisture. “Moist” food refers to a food composition that has a moisture content of about 60 to 90% or greater. “Dry” food refers to a food composition with about 3 to about 11% moisture content and is often manufactured in the form of small bits or kibbles.

The amount of moisture present in food composition may be from about 1 to about 90% by weight, about 1 to about 70% by weight, about 1 to about 50% by weight, about 1 to about 35% by weight, about 1 to about 20% by weight, about 1 to about 15% by weight, about 1 to about 13% by weight, about 1 to about 11% by weight, about 1 to about 10% by weight, about 1 to about 9% by weight, about 1 to about 8% by weight, about 1 to about 7% by weight, about 1 to about 6% by weight, about 1 to about 5% by weight, about 1 to about 4% by weight, about 1 to about 3% by weight; about 3 to about 90% by weight, about 3 to about 70% by weight, about 3 to about 50% by weight, about 3 to about 35% by weight, about 3 to about 20% by weight, about 3 to about 15% by weight, about 3 to about 13% by weight, about 3 to about 11% by weight, about 3 to about 10% by weight, about 3 to about 9% by weight, about 3 to about 8% by weight, about 3 to about 7% by weight, about 3 to about 6% by weight, about 3 to about 5% by weight; about 4 to about 90% by weight, about 4 to about 70% by weight, about 4 to about 50% by weight, about 4 to about 35% by weight, about 4 to about 20% by weight, about 4 to about 15% by weight, about 4 to about 13% by weight, about 4 to about 11% by weight, about 4 to about 10% by weight, about 4 to about 9% by weight, about 4 to about 8% by weight, about 4 to about 7% by weight; about 5 to about 90% by weight, about 5 to about 70% by weight, about 5 to about 50% by weight, about 5 to about 35% by weight, about 5 to about 20% by weight, about 5 to about 15% by weight, about 5 to about 13% by weight, about 5 to about 11% by weight, about 5 to about 10% by weight, about 5 to about 9% by weight, about 5 to about 8% by weight, about 5 to about 7% by weight, including ranges and subranges therebetween, based on the weight of the pet food composition.

In certain aspects, the present application further discloses a method of making any of the compositions of the present disclosure. In preparing a composition of the present invention in wet or canned form, any ingredient (e.g., AA, EPA, DHA) generally can, for example, be incorporated into the composition during the processing of the formulation, such as during and/or after mixing of other components of the composition. Distribution of these components into the composition can be accomplished by conventional means. In some embodiments, ground animal and poultry proteinaceous tissues are mixed with the other ingredients, including fish oils, cereal grains, other nutritionally balancing ingredients, special-purpose additives (e.g., vitamin and mineral mixtures, inorganic salts, cellulose and beet pulp, bulking agents, and the like); and water that is sufficient for processing is also added. These ingredients can be mixed in a vessel suitable for heating while blending the components. Heating of the mixture can be effected using any suitable manner, such as, for example, by direct steam injection or by using a vessel fitted with a heat exchanger. Following the addition of the last ingredient, the mixture can be heated to a temperature range of from about 50° F. (10° C.) to about 212° F. (100° C.). In some instances, the mixture can be heated to a temperature range of from about 70° F. (21° C.) to about 140° F. (60° C.). Temperatures outside these ranges are generally acceptable but may be commercially impractical without use of other processing aids. When heated to the appropriate temperature, the material will typically be in the form of a thick liquid. The thick liquid can be filled into cans. When filled into cans, a lid is applied, and the container is hermetically sealed. The sealed can is then placed into conventional equipment designed to sterilize the contents. This is usually accomplished by heating to temperatures of greater than about 230° F. (110° C.) for an appropriate time, which is dependent on, for example, the temperature used and the composition.

Pet food compositions can alternatively be prepared in a dry form using conventional processes. Typically, dry ingredients, including, for example, animal protein, plant protein, grains, etc., are ground and mixed together. Moist or liquid ingredients, including fats, oils, animal protein, water, etc., are then added to and mixed with the dry mix. The mixture is then processed into kibbles or similar dry pieces. Kibble is often formed using an extrusion process in which the mixture of dry and wet ingredients is subjected to mechanical work at a high pressure and temperature, and forced through small openings and cut off into kibble by a rotating knife. The wet kibble is then dried and optionally coated with one or more topical coatings which may include, for example, flavors, fats, oils, powders, and the like. Kibble also can be made from the dough using a baking process, rather than extrusion, wherein the dough is placed into a mold before dry-heat processing.

In another aspect, the present disclosure provides a method for increasing the amount of circulating vitamin E within a canine or feline, comprising feeding the animal a pet food composition comprising betaine and at least two omega-3 polyunsaturated fatty acids, wherein each of the at least two omega-3 polyunsaturated fatty acids comprise an unbranched aliphatic tail having at least 20 carbons; in an amount effective to increase the circulating vitamin E within the animal. In a preferred embodiment, such increase in the amount of vitamin E is more than would occur under conditions where one or more of the specified ingredients are not present. In certain embodiments, the at least two omega-3 polyunsaturated fatty acids comprise eicosapentaenoic acid (EPA) and docosahexaenoic acid (DHA). In certain embodiments, the at least two omega-3 polyunsaturated fatty acids are present in an amount of from about 0.2% to about 1%, about 0.2% to about 0.8%, or about 0.2% to about 0.5%, based on the dry weight of the pet food composition. The ratio of betaine to the at least two omega-3 polyunsaturated fatty acids may be from 1:1 to 2.5:1, from 1.3:1 to 2.0:1, or about 1.7:1. The betaine may be present in an amount of 0.03 to 1%, by weight, of the pet food composition. The at least two omega-3 polyunsaturated fatty acids may be derived from fish oil. In certain embodiments, the composition further comprises alpha-linolenic acid. In certain embodiments, the alpha-linolenic acid may be present in an amount of from about 0.3% to about 1%, based on the dry weight of the pet food composition.

In another aspect, the present disclosure provides a method for increasing the amount of circulating EPA and DHA within a canine or feline, comprising feeding the animal a pet food composition comprising betaine and at least two omega-3 polyunsaturated fatty acids, wherein each of the at least two omega-3 polyunsaturated fatty acids comprise an unbranched aliphatic tail having at least 20 carbons; in an amount effective to increase the circulating vitamin E within the animal. In a preferred embodiment, such increase in the amount of EPA and DHA is more than would occur under conditions where one or more of the specified ingredients (i.e. betaine) are not present. In certain embodiments, the at least two omega-3 polyunsaturated fatty acids comprise eicosapentaenoic acid (EPA) and docosahexaenoic acid (DHA). In certain embodiments, the at least two omega-3 polyunsaturated fatty acids are present in an amount of from about 0.2% to about 1%, about 0.2% to about 0.8%, or about 0.2% to about 0.5%, based on the dry weight of the pet food composition. The ratio of betaine to the at least two omega-3 polyunsaturated fatty acids may be from 1:1 to 2.5:1, from 1.3:1 to 2.0:1, or about 1.7:1. The betaine may be present in an amount of 0.03 to 1%, by weight, of the pet food composition. The at least two omega-3 polyunsaturated fatty acids may be derived from fish oil. In certain embodiments, the composition further comprises alpha-linolenic acid. In certain embodiments, the alpha-linolenic acid may be present in an amount of from about 0.3% to about 1%, based on the dry weight of the pet food composition.

In some embodiments, the present invention provides a pet food composition comprising betaine and at least two omega-3 polyunsaturated fatty acids in an amount effective to increase the circulatory concentration of one or more of EPA, DHA, and vitamin E in a pet, the diet having betaine and at least two omega-3 polyunsaturated fatty acids, wherein each of the at least two omega-3 polyunsaturated fatty acids comprise an unbranched aliphatic tail having at least 20 carbons. In a preferred embodiment, the increase in circulatory concentration is more so than would occur if the composition lacked betaine and at least two omega-3 polyunsaturated fatty acids. In certain aspects, the pet is a dog. In other aspects, the pet is a cat.

### EXAMPLES

The examples and other implementations described herein are exemplary and not intended to be limiting in describing the full scope of compositions and methods of this disclosure. Equivalent changes, modifications and variations of specific implementations, materials, compositions and methods may be made within the scope of the present disclosure, with substantially similar results.

### Example 1

Analysis of food containing betaine and long chain n3 polyunsaturated fatty acids was performed on cats. Forty eight cats were included in the analysis. Cats were maintained at a prefeed period of 14 days and then assigned to one of the following six food compositions: 1) control (moisture 6.8%, protein 33.4%, fat 19.2%, fiber (crude) 1.6%, ash 4.9%, betaine 736 mg/kg (0.0736 wt. %), alpha-linolenic acid (ALA) 0.15%, EPA and DHA both below level of detection (<0.02%)), 2) control+0.35% alpha-linolenic acid (ALA), 3) control+0.27% eicosapentaenoic acid (EPA) and docosahexaenoic acid (DHA), 4) control+0.5% betaine, 5) control+0.35% alpha-linolenic acid+0.5% betaine, or 6) control+0.27% EPA and DHA+0.5% betaine. The six food compositions are shown in Table 1, shown below. All treatment foods were fed for sixty days.

TABLE 1
Pet Food Compositions

| | Control Food | Food | Food | Food | Food | Food |
|---|---|---|---|---|---|---|
| | Composition | Composition | Composition | Composition | Composition | Composition |
| | 1 (wt. %) | 2 (wt. %) | 3 (wt. %) | 4 (wt. %) | 5 (wt. %) | 6 (wt. %) |
| Moisture | 6.8 | 6.8 | 6.8 | 6.8 | 6.8 | 6.8 |
| Protein | 33.4 | 33.4 | 33.4 | 33.4 | 33.4 | 33.4 |
| Fat | 19.2 | 19.2 | 19.2 | 19.2 | 19.2 | 19.2 |
| Fiber (crude) | 1.6 | 1.6 | 1.6 | 1.6 | 1.6 | 1.6 |
| Ash | 4.9 | 4.9 | 4.9 | 4.9 | 4.9 | 4.9 |
| Betaine | 0.0736 | 0.0736 | 0.0736 | 0.5 | 0.5 | 0.5 |
| α-Linolenic acid | 0.15 | 0.35 | 0.15 | 0.15 | 0.35 | 0.15 |
| EPA and DHA | <0.02 | <0.02 | 0.27 | <0.02 | <0.02 | 0.27 |

Measurement of circulating vitamin E (alpha tocopherol) was made and the results reported in Table 2. The change in circulating vitamin E concentration, or ΔE, was calculated as (ln final)−(ln initial). PUFA means polyunsaturated fatty acids and comprises both EPA and DHA.

TABLE 2
Change in circulating vitamin E in cats.

| Betaine | PUFA | ΔE | Std. Error | Pr > \|t\| |
|---|---|---|---|---|
| 0 | 0 | 0.122 | 0.134 | 0.136 |
| 0 | 0.27 wt. % | −0.180 | 0.134 | <0.001 |
| 0.5 wt. % | 0 | 0.517 | 0.134 | <0.001 |
| 0.5 wt. % | 0.27 wt. % | 0.807 | 0.126 | <0.001 |

The observed results surprisingly showed that inclusion of betaine with EPA and DHA (treatment 6) within the food effected a synergistic increase in the circulatory concentration of EPA and DHA. Further, animals on this treatment also showed reduced circulating concentration of alkaline phosphatase and blood urea nitrogen, both signs of liver and kidney health, respectively. Interestingly, although betaine synergistically increased the circulating concentrations of both fatty acids, there was a greater synergism for DHA (regression slope was 0.40 for DHA compared to 0.17 for EPA).

### Example 2

Analysis for effects of food containing betaine and long chain n3 polyunsaturated fatty acids was performed on dogs. Sixty four dogs were included in the analysis. Dogs were maintained at a prefeed period of 14 days and then assigned to one of various treatment foods; 1) 0.05% betaine+0.25% alpha-linolenic acid (ALA), 2) 0.05% betaine+0.81% ALA, 3) 0.47% betaine+0.85% ALA, 4) 0.28% eicosapentaenoic acid (EPA) and docosahexaenoic acid (DHA), 5) 0.55% betaine+0.28% EPA and DHA, or 6) 0.58% betaine. The six food compositions are shown in Table 3, provided below. All treatment foods were fed for sixty days.

TABLE 3
Pet Food Compositions

| | Control Food | Food | Food | Food | Food | Food |
|---|---|---|---|---|---|---|
| | Composition | Composition | Composition | Composition | Composition | Composition |
| | 1 (wt. %) | 2 (wt. %) | 3 (wt. %) | 4 (wt. %) | 5 (wt. %) | 6 (wt. %) |
| Moisture | 6.8 | 6.8 | 6.8 | 6.8 | 6.8 | 6.8 |
| Protein | 33.4 | 33.4 | 33.4 | 33.4 | 33.4 | 33.4 |
| Fat | 19.2 | 19.2 | 19.2 | 19.2 | 19.2 | 19.2 |
| Fiber (crude) | 1.6 | 1.6 | 1.6 | 1.6 | 1.6 | 1.6 |
| Ash | 4.9 | 4.9 | 4.9 | 4.9 | 4.9 | 4.9 |
| Betaine | 0.05 | 0.05 | 0.47 | 0.05 | 0.55 | 0.58 |
| α-Linolenic acid | 0.25 | 0.81 | 0.85 | 0 | 0 | 0 |
| EPA and DHA | 0 | 0 | 0 | 0.28 | 0.28 | 0 |

Measurement of circulating vitamin E (alpha tocopherol) was made and the results reported in Table 4. The change in circulating vitamin E concentration, or ΔE, was calculated as (ln final)−(ln initial). PUFA means polyunsaturated fatty acids and comprises both EPA and DHA.

TABLE 4
Change in circulating vitamin E in dogs.

| Betaine | PUFA | ΔE | Std. Error | Pr > \|t\| |
|---|---|---|---|---|
| 0 | 0 | −0.022 | 0.050 | 0.6627 |
| 0 | 0.28 wt. % | −0.095 | 0.050 | 0.0649 |
| 0.5 wt. % | 0 | −0.004 | 0.050 | 0.9283 |
| 0.5 wt. % | 0.28 wt. % | 0.0899 | 0.050 | 0.0798 |

As shown in Table 4, only the addition of both betaine and polyunsaturated fatty acids resulted in positive enhancement of circulating vitamin E. From this data, it is estimated that in order to see such a benefit, dog food must contain a minimum amount of betaine and combined EPA and DHA. The calculation was made as follows: the relationship of the change in vitamin E (represented as ΔE in Table 4) was evaluated by independently changing intake of betaine and the combined EPA and DHA (20+ carbon length fatty acids). The results showed a linear response for betaine and the 20+ carbon fatty acids. The point where ΔE becomes positive is the concentration where a benefit was observed. This was observed at an intake of 0.425 grams betaine in 193 grams of dog food (the 193 grams being the amount of dog food expected to be consumed by this wet dog), or 0.22%, based on the dry weight of the pet food composition. It is further estimated that EPA and DHA must be present at least at 0.170 grams in 193 grams of dog food, or 0.09%, based on the dry weight of the pet food composition.

TABLE 5
Change in Circulating EPA

| Betaine | PUFA | ΔEPA | Std. Error | Pr > \|t\| |
|---|---|---|---|---|
| 0 | 0 | −0.34 | 0.42 | 0.42 |
| 0 | 0.28 wt. % | 4.14 | 0.42 | <0.001 |
| 0.5 wt. % | 0 | −0.23 | 0.42 | 0.59 |
| 0.5 wt. % | 0.28 wt. % | 4.62 | 0.42 | <0.001 |

TABLE 6
Change in circulating DHA

| Betaine | PUFA | ΔDHA | Std. Error | Pr > \|t\| |
|---|---|---|---|---|
| 0 | 0 | −1.15 | 0.91 | 0.21 |
| 0 | 0.28 wt. % | 6.30 | 0.90 | <0.001 |
| 0.5 wt. % | 0 | −0.91 | 0.91 | 0.9283 |
| 0.5 wt. % | 0.28 wt. % | 8.29 | 0.92 | <0.001 |

Table 5 shows a surprising interaction of betaine and PUFA intake such that the presence of betaine increased circulating EPA as compared to the PUFA intake alone. Table 6 shows a surprising interaction of betaine and PUFA intake such that the presence of betaine increased circulating DHA as compared to the PUFA intake alone

While the present invention has been described with reference to several embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention is to be determined from the claims appended hereto. Further, it will be apparent to those of skill in the art that numerous changes may be made in such details without departing from the spirit and the principles of the invention.

1-35. (canceled)

36. A pet food composition comprising:
betaine; and
at least two omega-3 polyunsaturated fatty acids;
wherein each of the at least two omega-3 polyunsaturated fatty acids comprise an unbranched aliphatic tail having at least 20 carbons.

37. The pet food composition according to claim 36, wherein the at least two omega-3 polyunsaturated fatty acids comprise eicosapentaenoic acid (EPA) and docosahexaenoic acid (DHA).

38. The pet food composition according to claim 36, wherein the at least two omega-3 polyunsaturated fatty acids are present in an amount of from about 0.09% to about 1%, about 0.1% to about 0.8%, or about 0.2% to about 0.5%, based on the dry weight of the pet food composition.

39. The pet food composition according to claim 36, wherein the betaine is present in an amount of about 0.03 to about 1%, based on the dry weight of the pet food composition.

40. The pet food composition according to claim 36, wherein the weight ratio of betaine to the at least two omega-3 polyunsaturated fatty acids is from about 1:1 to about 2.5:1.

41. The pet food composition according to claim 36, wherein the weight ratio of betaine to the at least two omega-3 polyunsaturated fatty acids is from about 1.3:1 to about 2.0:1.

42. The pet food composition according to claim 36, wherein the weight ratio of betaine to the at least two omega-3 polyunsaturated fatty acids is about 1.7:1.

43. The pet food composition according to claim 36, wherein the at least two omega-3 polyunsaturated fatty acids are derived from fish oil.

44. The pet food composition according to claim 36, wherein the composition further comprises alpha-linolenic acid.

45. The pet food composition according to claim 44, wherein the alpha-linolenic acid is present in an amount of from about 0.3% to about 1%, based on the dry weight of the pet food composition.

46. The pet food composition of claim 36, wherein the pet food composition has a weight ratio of the betaine to the total amount of eicosapentaenoic acid and docosahexaenoic acid of from about 1:2 to about 5:1.

47. A method for increasing the amount of circulating vitamin E within a canine, the method comprising feeding the canine in need thereof an effective amount of the pet food composition of claim 36.

48. A method for increasing the amount of circulating EPA and DHA within a feline, the method comprising feeding the feline in need thereof an effective amount of the pet food composition of claim 36.

49. A pet food composition comprising:
from about 10% to about 40% of protein;
from about 9 or more by weight % of fat;
from about 0.1 to about 10% by weight of fiber;
betaine; and
at least two omega-3 polyunsaturated fatty acid,
wherein each of the at least two omega-3 polyunsaturated fatty acids comprise an unbranched aliphatic tail having at least 20 carbons, and all weight percentages are based on the dry weight of the pet food composition.

50. The pet food composition of claim 49, wherein the at least two omega-3 polyunsaturated fatty acid comprises linolenic acid, stearidonic acid, eicosatetraenoic acid, eicosapentaenoic acid, docosapentaenoic acid, docosahexaenoic acid, or a combination thereof.

51. The pet food composition of claim 49, wherein the at least two omega-3 polyunsaturated fatty acids are selected from eicosapentaenoic acid, docosahexaenoic acid, linolenic acid, or a combination thereof.

52. The pet food composition of claim 51, wherein the at least two omega-3 polyunsaturated fatty acid comprises eicosapentaenoic acid and docosahexaenoic acid.

53. The pet food composition of claim 52, wherein the pet food composition comprises a weight ratio of eicosapentaenoic acid to docosahexaenoic acid of from about 1:5 to about 5:1.

54. The pet food composition of claim 49, wherein the pet food composition has a weight ratio of the betaine to the at least two omega-3 polyunsaturated fatty acid of from about 1:2 to about 5:1.

55. The pet food composition of claim 52, wherein the pet food composition has a weight ratio of the betaine to the total amount of eicosapentaenoic acid and docosahexaenoic acid of from about 1:2 to about 5:1.
